(19) United States
(12) Patent Application Publication
(10) Pub. No.: US 2013/0279192 A1
(43) Pub. Date: Oct. 24, 2013

(54) PRISM LIGHT GUIDE PLATE AND CORRESPONDING BACKLIGHT MODULE

(71) Applicants: Kuangyao Chang, Shenzhen (CN); Wei Fan, Shenzhen (CN)

(72) Inventors: Kuangyao Chang, Shenzhen (CN); Wei Fan, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/636,644

(22) PCT Filed: May 24, 2012
(86) PCT No.: PCT/CN12/75986

§ 371 Date: Sep. 21, 2012

(30) Foreign Application Priority Data
Apr. 18, 2012 (CN) 201210113714.4

(51) Int. Cl. F21V 8/00

(52) U.S. Cl. 362/607

(57) ABSTRACT

The present invention relates a prism light guide plate and a corresponding backlight module. The prism light guide plate includes a plate body. The plate body has a plurality of bar-shaped prisms disposed on a light-exiting surface of the plate body and at least one light-absorption layer disposed on at least one side surface of the plate body. The present invention disposes the light-absorption layer on the side surface of the plate body to reduce or eliminate the bright lines at the side surfaces of the prism light guide plate so that the technical problem of bright lines occurring at the side surfaces of a conventional prism light guide plate can be effectively solved.

### BACKGROUND OF THE INVENTION

1. Field of the Invention

The present invention relates to a field of liquid crystal display technology, especially to a prism light guide plate and a corresponding backlight module that enhance the display quality of a liquid crystal display device.

2. Description of the Related Art

Liquid crystal display devices have been widely used in many kinds of electronic products. Liquid crystal display devices are mostly backlight-type liquid crystal devices that have a liquid crystal panel and a backlight module. Backlight modules are sorted into side-light type and direct-light type based on the incident position of their light sources, wherein side-light type backlight module is more used.

In order to increase the brightness of a backlight module as more as possible, designers have developed a prism light guide plate. With reference to FIG. 1, which is a structural view of a conventional side-light type backlight module having a prism light guide plate, the side-light type backlight module includes a light guide plate 11 and a light source 12. The light guide plate 11 is a kind of prism light guide plate that has multiple strip-shaped prisms 110 being parallel with each other and mounted on a light-exiting surface 115 of the light guide plate 11. Each of the light-exiting strip-shaped prisms 110 has a cross-sectional direction X that is basically parallel with an incident surface 112 of the light guide plate 11. The light source 12 generally is an LED light bar. After lights of the light source 12 are transmitted into the light guide plate 11 from the incident surface 112, the lights that propagate along an extension direction Y (which is basically perpendicular to the incident surface 112 of the light guide plate 11) of the strip-shaped prisms 110 may have a longer propagation distance due to total internal reflection; and the lights that propagate along the cross-sectional direction X of the strip-shaped prisms 110 may have a shorter propagation distance because total internal reflection does not easily occur and therefore it performs a certain converging effect for the lights of the light source 12 and enhances the light efficiency of the light source 12.

With reference to FIGS. 2A and 2B, FIG. 2A is a top view of the conventional side-light type backlight module having a prism light guide plate and FIG. 2B is a cross-sectional view taken along the line A-A in FIG. 2A. The light guide plate 11 has fixing portions 114 formed at side surfaces 113 where being perpendicular to the incident surface 112 (generally close to the incident surface 112). The fixing portions 114 are used to be engaged with a frame of a backlight module to fix the position of the incident surface 112 of the light guide plate 11.

The existence of the fixing portions 114 makes the side surfaces 113 to be uneven. When the backlight module is working, clear bright lines B may occur at the light-exiting surface 115 close to the side surfaces 113 (especially when looking along the cross-sectional direction X). However, if the light guide plate 11 has even side surfaces 113, the incident surface 112 of the light guide plate 11 cannot be effectively fixed, when the backlight module is switched between working state and non-working state, the light guide plate 11 will expand from the heat and contract from the cold such that it is difficult to ensure the constancy of an incident distance between the incident surface 112 of the light guide plate 11 and the light source 12 and thereby affecting the light outputting efficiency of the backlight module.

Therefore, it is necessary to provide a prism light guide plate and a corresponding backlight module to overcome the problems existing in the conventional technology.

### SUMMARY OF THE INVENTION

The present invention provides a prism light guide plate and a corresponding backlight module which dispose a light-absorption layer at each of two side surfaces of the prism light guide plate so as to reduce or eliminate the bright lines at the side surfaces of the prism light guide plate so that the technical problem of bright lines occurring at the side surfaces of a conventional prism light guide plate can be effectively solved.

The present invention relates to a prism light guide plate having: a plate body having a light-exiting surface, a plurality of bar-shaped prisms, an incident surface and two side surfaces, wherein the bar-shaped prisms are mounted on the light-exiting surface and parallel to each other, the incident surface is perpendicular to a length direction of the bar-shaped prisms, and the side surfaces are parallel to the length direction of the bar-shaped prisms; and two light-absorption layers being respectively disposed on the side surfaces of the plate body; and the light absorption rate of the light-absorption layers is ranged between 30% and 80%; and the light-absorption layers are directly attached to the side surfaces.

In one embodiment of the prism light guide plate of the present invention, each of the side surfaces includes a fixing portion for fixing the plate body; and each of the light-absorption layers is mounted at the fixing portion on each of the side surfaces.

The present invention further relates to a prism light guide plate having: a plate body having a light-exiting surface, a plurality of bar-shaped prisms, an incident surface and two side surfaces, wherein the bar-shaped prisms are mounted on the light-exiting surface and parallel to each other, the incident surface is perpendicular to a length direction of the bar-shaped prisms, and the side surfaces are parallel to the length direction of the bar-shaped prisms; and two light-absorption layers being respectively disposed on the side surfaces of the plate body.

In one embodiment of the prism light guide plate of the present invention, the light absorption rate of the light-absorption layers is ranged between 30% and 80%.

In one embodiment of the prism light guide plate of the present invention, the light-absorption layers are directly attached to the side surfaces.

In one embodiment of the prism light guide plate of the present invention, each of the light-absorption layers is a light-absorption coating.

In one embodiment of the prism light guide plate of the present invention, each of the light-absorption layers is a light-absorption adhesive tape.

In one embodiment of the prism light guide plate of the present invention, each of the light-absorption layers is a combination of a light-absorption coating and a light-absorption adhesive tape.

In one embodiment of the prism light guide plate of the present invention, the light-absorption adhesive tape is directly attached to the side surface, and the light-absorption coating is coated on the light-absorption adhesive tape.

In one embodiment of the prism light guide plate of the present invention, each of the side surfaces includes a fixing portion for fixing the plate body.

In one embodiment of the prism light guide plate of the present invention, each of the light-absorption layers is mounted at the fixing portion on each of the side surfaces.

The present invention further relates to a backlight module having a light source; and a prism light guide plate mounted at a side of a light-emitting surface of the light source and having a plate body having a light-exiting surface, a plurality of bar-shaped prisms, an incident surface and two side surfaces, wherein the bar-shaped prisms are mounted on the light-exiting surface and parallel to each other, the incident surface is perpendicular to a length direction of the bar-shaped prisms and facing the light-emitting surface of the light source, and the side surfaces are parallel to the length direction of the bar-shaped prisms; and two light-absorption layers being respectively disposed on the side surfaces of the plate body.

In one embodiment of the backlight module of the present invention, the light absorption rate of the light-absorption layers is ranged between 30% and 80%.

In one embodiment of the backlight module of the present invention, the light-absorption layers are directly attached to the side surfaces.

In one embodiment of the backlight module of the present invention, each of the light-absorption layers is a light-absorption coating.

In one embodiment of the backlight module of the present invention, each of the light-absorption layers is a light-absorption adhesive tape.

In one embodiment of the backlight module of the present invention, each of the light-absorption layers is a combination of a light-absorption coating and a light-absorption adhesive tape.

In one embodiment of the backlight module of the present invention, the light-absorption adhesive tape is directly attached to the side surface, and the light-absorption coating is coated on the light-absorption adhesive tape.

In one embodiment of the backlight module of the present invention, each of the side surfaces includes a fixing portion for fixing the plate body.

In one embodiment of the backlight module of the present invention, each of the light-absorption layers is mounted at the fixing portion on each of the side surfaces.

Implementing the prism light guide plate and the corresponding backlight module of the present invention has following advantages: disposing light-absorption layers at the two side surfaces of the prism light guide plate can reduce or eliminate the bright lines at the side surfaces of the prism light guide plate so that the technical problem of bright lines occurring at the side surfaces of a conventional prism light guide plate can be effectively solved.

This invention is detailed described with reference to the following preferred embodiments and the accompanying drawings, where the aforementioned contents of this invention can be made more clear and understandable.

### BRIEF DESCRIPTION OF THE DRAWINGS

FIG. 1 is a structural view of a conventional side-light type backlight module having a prism light guide plate;

FIG. 2A is a top view of a conventional side-light type backlight module having a prism light guide plate;

FIG. 2B is a cross-sectional view taken along the line A-A in FIG. 2A;

FIG. 3 is a structural side view of a prism light guide plate taken along the line A-A in FIG. 2A according to a first embodiment of the present invention;

FIG. 4 is a structural side view of a prism light guide plate taken along the line A-A in FIG. 2A according to a second embodiment of the present invention;

FIG. 5 is a structural side view of a prism light guide plate taken along the line A-A in FIG. 2A according to a third embodiment of the present invention.

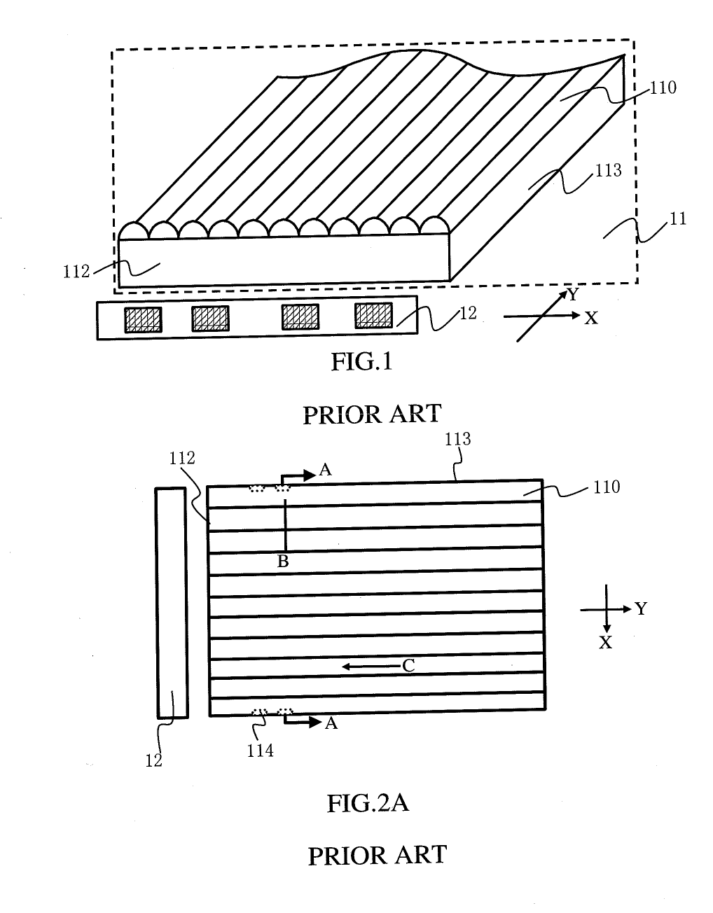

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

In the drawings, units with similar structure are labeled with the same reference number.

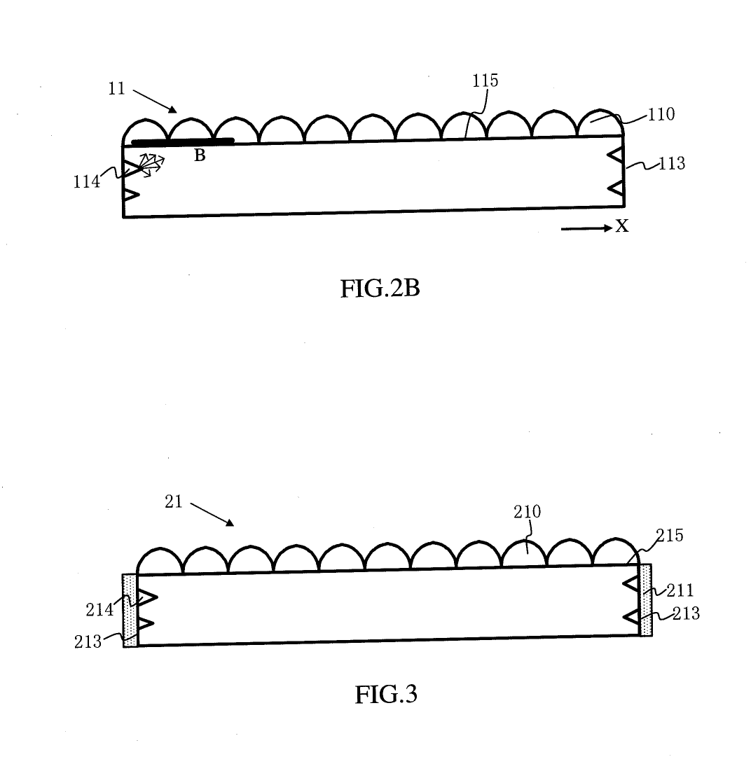

With reference to FIG. 2A and FIG. 3, FIG. 3 is a structural side view of a prism light guide plate taken along the line A-A in FIG. 2A according to a first embodiment of the present invention. The prism light guide plate 21 comprises a plate body, and the plate body has a plurality of bar-shaped prisms 210, an incident surface, two side surfaces 213 and a light-exiting surface 215. The incident surface is perpendicular to a length direction of the bar-shaped prisms 210. The side surfaces 213 are parallel to the length direction of the bar-shaped prisms 210. The light-exiting surface 215 is perpendicular to the side surfaces 213 and the incident surface. The bar-shaped prisms 210 are mounted on the light-exiting surface 215 and parallel to each other. The length direction of the bar-shaped prism 210 means the extension direction C of a longer side of each of the bar-shaped prism 210. Each of the side surfaces 213 of the prism light guide plate 21 includes a fixing portion 214 that is used to be engaged with a frame of a corresponding backlight module so that the position of the incident surface can be fixed to ensure that the constancy of an incident distance between the incident surface of the prism light guide plate 21 and a light-emitting surface of a light source. Each of the side surfaces 213 of the prism light guide plate 21 further has a light-absorption layer 211 (or a low reflectivity layer) mounted thereon for absorbing a part of the lights that are reflected to the side surfaces 213 of the prism light guide plate 21 (especially those lights that are reflected to the fixing portions 214 of the prism light guide plate 21) to reduce or eliminate the bright lines at the side surfaces 213 of the prism light guide plate 21.

While specifically implementing the technical solution of the present invention, if the light absorption rate of the light-absorption layer 211 is too low (or the reflectivity is too high), it will not achieve good effects on reducing or eliminating the bright lines; if the light absorption rate of the light-absorption layer 211 is too high (or the reflectivity is too low), then dark lines may occur at the position near the side surfaces 213 of the prism light guide plate 21. Hence, the light absorption rate of the light-absorption layers 211 is preferably ranged between 30% and 80% (that is, the reflectivity is ranged between 20% and 70%) so that the effects on reducing or eliminating the bright lines can be achieved well while no extra dark lines are produced.

When the backlight module of the present invention is being used, the side surfaces 213 of the prism light guide plate 21 has the light-absorption layers 211 mounted thereon, and preferably the light-absorption layers 211 are directly attached to the side surfaces 213 of the prism light guide plate 21, and especially, each of the light-absorption layers 211 is mounted at the fixing portion 214 on each of the side surfaces 213. Thus, a part of the lights that travel to the fixing portion 214 of each of the side surfaces 213 of the prism light guide plate 21 will be absorbed by the light-absorption layers 211 so that irregular light reflection or scattering caused by the fixing portions 214 (because the fixing portions 214 cause the side surfaces 213 to be uneven) can be reduced, and then the bright lines occurring at the position near the side surfaces 213 can be reduced or eliminated.

In this embodiment, each of the light-absorption layers 211 is light-absorption coating (also called low reflectivity coating). For example, use a colored oily marker pen (for example, a black oily marker pen) to coat a colored oily coating on the side surfaces 213 of the prism light guide plate 21 so as to use the colored oily coating to change the light absorption rate (or light reflectivity) of the side surfaces 213 (especially the fixing portions 214 on the side surfaces 213), and thereby reducing or eliminating the bright lines at the positions near the side surfaces 213. The light-absorption layer 211 may be mounted on the entire side surface 213 of the prism light guide plate 21 or it can be mounted only at the fixing portions 214 of the side surfaces 213 which are worst affected by irregular light reflection or scattering.

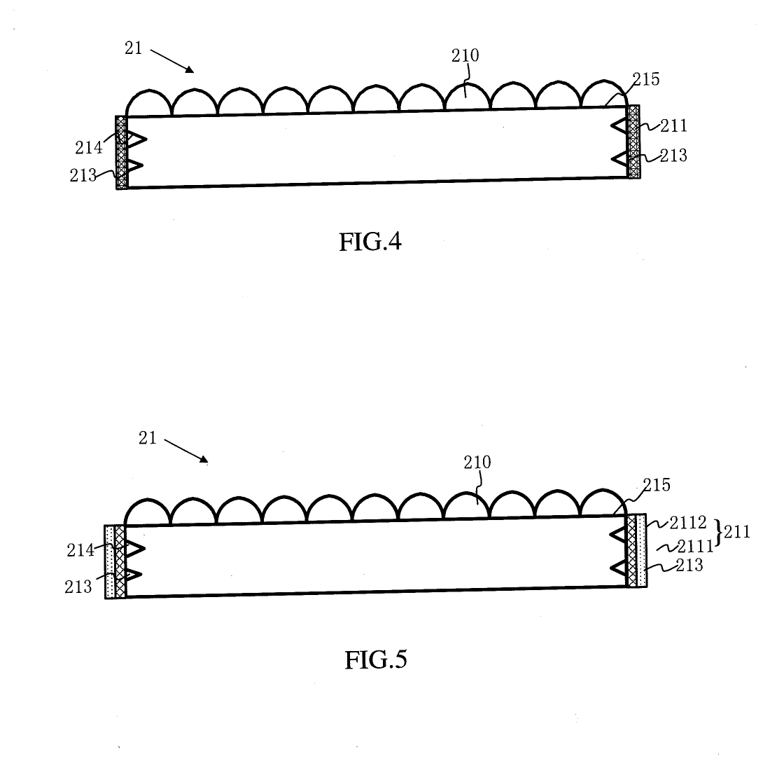

With reference to FIG. 4, FIG. 4 is a structural side view of a prism light guide plate taken along the line A-A in FIG. 2A according to a second embodiment of the present invention. The embodiment differs from the first embodiment in that the light-absorption layer 211 mounted on the side surfaces 213 of the prism light guide plate 21 is a light-absorption adhesive tape (also called low reflectivity adhesive tape.

In this embodiment, the light-absorption adhesive tape may be a double-sided adhesive tape with a specific color and may be directly attached to the side surface 213 of the prism light guide plate 21 so as to change the light absorption rate (or light reflectivity) of the side surfaces 213 (especially the fixing portions 214 on the side surfaces 213), and thereby reducing or eliminating the bright lines at the positions near the side surfaces 213. Using the light-absorption adhesive tape does not affect the light guiding effect of the prism light guide plate 21. The specific mounting positions, the selection of light absorption rate of material and the beneficial effects in this embodiment are the same as or similar to those in the first embodiment, no more tautology here.

With reference to FIG. 5, FIG. 5 is a structural side view of a prism light guide plate taken along the line A-A in FIG. 2A according to a third embodiment of the present invention. This embodiment differs from the first embodiment in that the light-absorption layer 211 is a combination of a light absorption coating 2111 and a light-absorption adhesive tape 2112, wherein the light-absorption adhesive tape 2112 is directly attached to the side surface 213 of the prism light guide plate 21, and the light-absorption coating 2111 is coated on the light-absorption adhesive tape 2112.

In this embodiment, the light-absorption adhesive tape 2112 may be a double-sided adhesive tape with a specific color and the light-absorption coating 2111 may be a colored oily coating (for example, a black oily coating). The specific implementation is to directly attach the light-absorption adhesive tape 2112 to the side surface 213 of the prism light guide plate 21, and then use a colored oily marker pen to coat a colored oily coating on the light-absorption adhesive tape 2112 so as to change the light absorption rate of the side surfaces 213 (especially the fixing portions 214 on the side surfaces 213), and thereby reducing or eliminating the bright lines at the positions near the side surfaces 213. Using the combination of the light-absorption coating 2111 and the light-absorption adhesive tape 2112 not only prevents the light-absorption layer 211 from affecting the light guiding effect of the prism but also achieve the best effect of reducing or eliminating the bright lines at the positions near the side surfaces 213. The specific mounting positions, the selection of light absorption rate of material and the beneficial effects in this embodiment are the same as or similar to those in the first embodiment, no more tautology here.

The present invention further relates to a backlight module. The backlight module comprises a light source and a prism light guide plate mounted at a side of a light-emitting surface of the light source. The light source is used to emit lights for image display. The prism light guide plate is used to guide the lights emitted by the light source to a corresponding display panel. The prism light guide plate has a plate body. The plate body includes a plurality of bar-shaped prisms, an incident surface, two side surfaces and a light-exiting surface. The incident surface is perpendicular to a length direction of the bar-shaped prisms and faces the light-emitting surface of the light source. The side surfaces are parallel to the length direction of the bar-shaped prisms. The light-exiting surface is perpendicular to the side surfaces and the incident surface. The bar-shaped prisms are mounted on the light-exiting surface and parallel to each other. Each of the side surfaces of the prism light guide plate has a light-absorption layer (or a low reflectivity layer) mounted thereon for absorbing a part of the lights that are reflected to the side surfaces of the prism light guide plate to reduce or eliminate the bright lines at the side surfaces of the prism light guide plate. The working principle and beneficial effects of the backlight module of the present invention are the same as or similar with the specific embodiments of the prism light guide plate described in the above description, therefore please refer to the above embodiments of the prism light guide plate.

By the above description, the prism light guide plate and the corresponding backlight module of the present invention is to dispose light-absorption layers at the two side surfaces of the prism light guide plate to reduce or eliminate the bright lines at the side surfaces of the prism light guide plate so that the technical problem of bright lines occurring at the side surfaces of a conventional prism light guide plate can be effectively solved.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A prism light guide plate comprising:
a plate body having a light-exiting surface, a plurality of bar-shaped prisms, an incident surface and two side surfaces, wherein the bar-shaped prisms are mounted on the light-exiting surface and parallel to each other, the incident surface is perpendicular to a length direction of the bar-shaped prisms, and the side surfaces are parallel to the length direction of the bar-shaped prisms; and
two light-absorption layers being respectively disposed on the side surfaces of the plate body; wherein
the light absorption rate of the light-absorption layers is ranged between 30% and 80%; and
the light-absorption layers are directly attached to the side surfaces.

2. The prism light guide plate as claimed in claim 1, wherein each of the side surfaces includes a fixing portion for fixing the plate body; and each of the light-absorption layers is mounted at the fixing portion on each of the side surfaces.

3. A prism light guide plate comprising:
a plate body having a light-exiting surface, a plurality of bar-shaped prisms, an incident surface and two side surfaces, wherein the bar-shaped prisms are mounted on the light-exiting surface and parallel to each other, the incident surface is perpendicular to a length direction of the bar-shaped prisms, and the side surfaces are parallel to the length direction of the bar-shaped prisms; and
two light-absorption layers being respectively disposed on the side surfaces of the plate body.

4. The prism light guide plate as claimed in claim 3, wherein the light absorption rate of the light-absorption layers is ranged between 30% and 80%.

5. The prism light guide plate as claimed in claim 3, wherein the light-absorption layers are directly attached to the side surfaces.

6. The prism light guide plate as claimed in claim 5, wherein each of the light-absorption layers is a light-absorption coating.

7. The prism light guide plate as claimed in claim 5, wherein each of the light-absorption layers is a light-absorption adhesive tape.

8. The prism light guide plate as claimed in claim 5, wherein each of the light-absorption layers is a combination of a light-absorption coating and a light-absorption adhesive tape.

9. The prism light guide plate as claimed in claim 8, wherein the light-absorption adhesive tape is directly attached to the side surface, and the light-absorption coating is coated on the light-absorption adhesive tape.

10. The prism light guide plate as claimed in claim 3, wherein each of the side surfaces includes a fixing portion for fixing the plate body.

11. The prism light guide plate as claimed in claim 10, wherein each of the light-absorption layers is mounted at the fixing portion on each of the side surfaces.

12. A backlight module comprising:
a light source; and
a prism light guide plate mounted at a side of a light-emitting surface of the light source and having:
a plate body having a light-exiting surface, a plurality of bar-shaped prisms, an incident surface and two side surfaces, wherein the bar-shaped prisms are mounted on the light-exiting surface and parallel to each other, the incident surface is perpendicular to a length direction of the bar-shaped prisms and facing the light-emitting surface of the light source, and the side surfaces are parallel to the length direction of the bar-shaped prisms; and
two light-absorption layers being respectively disposed on the side surfaces of the plate body.

13. The backlight module as claimed in claim 12, wherein the light absorption rate of the light-absorption layers is ranged between 30% and 80%.

14. The backlight module as claimed in claim 12, wherein the light-absorption layers are directly attached to the side surfaces.

15. The backlight module as claimed in claim 14, wherein each of the light-absorption layers is a light-absorption coating.

16. The backlight module as claimed in claim 14, wherein each of the light-absorption layers is a light-absorption adhesive tape.

17. The backlight module as claimed in claim 14, wherein each of the light-absorption layers is a combination of a light-absorption coating and a light-absorption adhesive tape.

18. The backlight module as claimed in claim 17, wherein the light-absorption adhesive tape is directly attached to the side surface, and the light-absorption coating is coated on the light-absorption adhesive tape.

19. The backlight module as claimed in claim 12, wherein each of the side surfaces includes a fixing portion for fixing the plate body.

20. The backlight module as claimed in claim 19, wherein each of the light-absorption layers is mounted at the fixing portion on each of the side surfaces.
